(19) United States
(12) Patent Application Publication
(10) Pub. No.: US 2019/0183608 A1
(43) Pub. Date: Jun. 20, 2019

(54) SURGICAL TOOL

(71) Applicants: Vince S. Warner, Alpine, UT (US); Judson Wall, Bountiful, UT (US)

(72) Inventors: Vince S. Warner, Alpine, UT (US); Judson Wall, Bountiful, UT (US)

(21) Appl. No.: 16/221,281

(22) Filed: Dec. 14, 2018

Related U.S. Application Data
(60) Provisional application No. 62/598,749, filed on Dec. 14, 2017.

(51) Int. Cl. A61C 3/03; A61C 1/00; A61C 1/14

(52) U.S. Cl. CPC A61C 3/03; A61C 1/07; A61C 1/148; A61C 1/0023

(57) ABSTRACT

A surgical tool with an improved drive system may feature an uneven, rotating, swash plate pushing against a spring biased driving shaft to transform rotary motion to linear motion. As the swash plate pushes forward, the spring tension increases and is then continually released as the swash plate is rotates to a point where less pressure is applied to the shaft. The motion is then smooth, continuous, and reciprocating. Various tool bits may be provided for various operations.

### CROSS-REFERENCES TO RELATED APPLICATIONS

This Application claims priority as a non-provisional perfection of prior filed U.S. Application No. 62/598,749, filed Dec. 14, 2017, and incorporates the same by reference herein in its entirety.

### FIELD OF THE INVENTION

The present invention relates to the field of dentistry and more particularly relates to an osculating tool for use in surgery, which may include loosening a tooth for extraction.

### BACKGROUND OF THE INVENTION

Dentistry is an old art, with ancient Egyptian mummies showing signs of dental work. One of the oldest practices is tooth extraction—where a diseased or broken tooth is pulled out of the jaw. Generally, the tooth structure is not made for easy extraction as at least one, possibly more, root structure is embedded in an individual's jaw for each tooth. Wrestling a tooth out of the jaw often requires strenuous effort on a practitioner and some measure of discomfort on the patient. And if not performed properly, serious harm can be done to the patients jaw and gums; often leading to corrective surgeries performed by oral surgeons.

To this end, many methods and tools for loosening a tooth prior to extraction have been developed. One tool is a dental hammer, often used with a chisel, to loosen, break apart and eventually extract a tooth. Recently, the dental hammer has been upgraded with a repeating hammer structure, much like a jackhammer, which may be used to separate the tooth from the jaw. However, current designs are linear in operation and have play in their linkages. Not only does this create an unacceptable level of noise, but the tools also tend to jerk when in use. The repeating hammer only provides force in one direction, and relies on momentum from the tool bouncing in order to return the hammer portion to an original position. This reliance on bounce force is unreliable. An osculating plunger design which eliminates these issues would be of great benefit to the art. A true reciprocating action also lends itself to various specialized tools other than just a plunger.

The present invention is a double acting osculating tool for dental use which utilizes an eccentric rotary plate to impart linear motion to the plunging implement. The present invention represents a departure from the prior art in that the use of the rotary plate in the present invention allows for quieter use while eliminating the vibration from prior art linear hammer drives.

### SUMMARY OF THE INVENTION

In view of the foregoing disadvantages inherent in the known types of dental hammers, an improved osculating surgical tool is provided. As such, a new and improved dental tool may comprise multiple tool heads actuated by a dual acting eccentric rotary drive in order to accomplish quieter and smoother operation. With multiple tool heads, it should be noted that uses outside the field of dentistry are possible.

The more important features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also, it is to be understood that the phraseology and terminology employed herein are for description and should not be regarded as limiting.

As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view of a dental surgical tool with an osculating head.

FIG. 2 is an exploded view of the dental surgical tool of FIG. 1.

FIG. 3 is a top plan view of the dental surgical tool of FIG. 2.

FIG. 4 is a sectional view of the dental surgical tool of FIG. 3, taken along line A-A.

FIG. 5 is a perspective view of the motor unit utilized in the dental surgical tool of FIG. 2.

FIG. 6 is a sectional view of the motor unit of FIG. 5, taken along line A-A of FIG. 3.

FIG. 7 is an exploded view of the motor unit of FIG. 5.

FIG. 8 is a perspective view of the wand head unit utilized in the dental surgical tool of FIG. 2.

FIG. 9 is a sectional view of the wand head unit of FIG. 8, taken along line A-A of FIG. 3.

FIG. 10 is an exploded view of the wand head unit of FIG. 8.

### DETAILED DESCRIPTION OF THE PREFERRED EMBODIMENT

With reference now to the drawings, a preferred embodiment of the dental surgical tool is herein described. It should be noted that the articles “a”, “an”, and “the”, as used in this specification, include plural referents unless the content clearly dictates otherwise. The term “longitudinal” shall be used to describe movement or structure along a major axis defined by the tool.

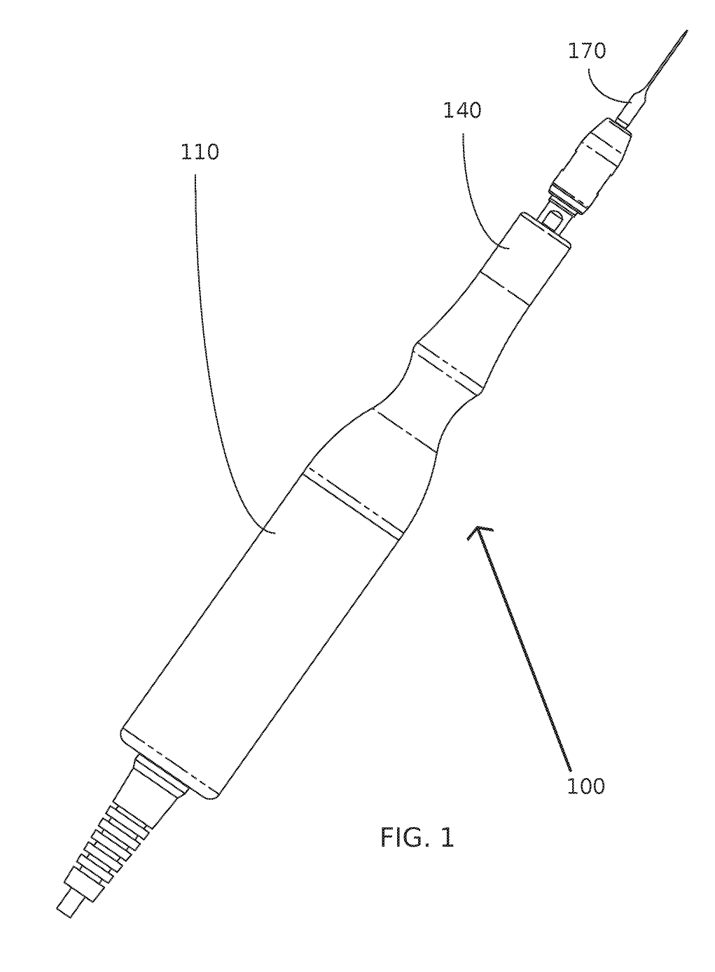

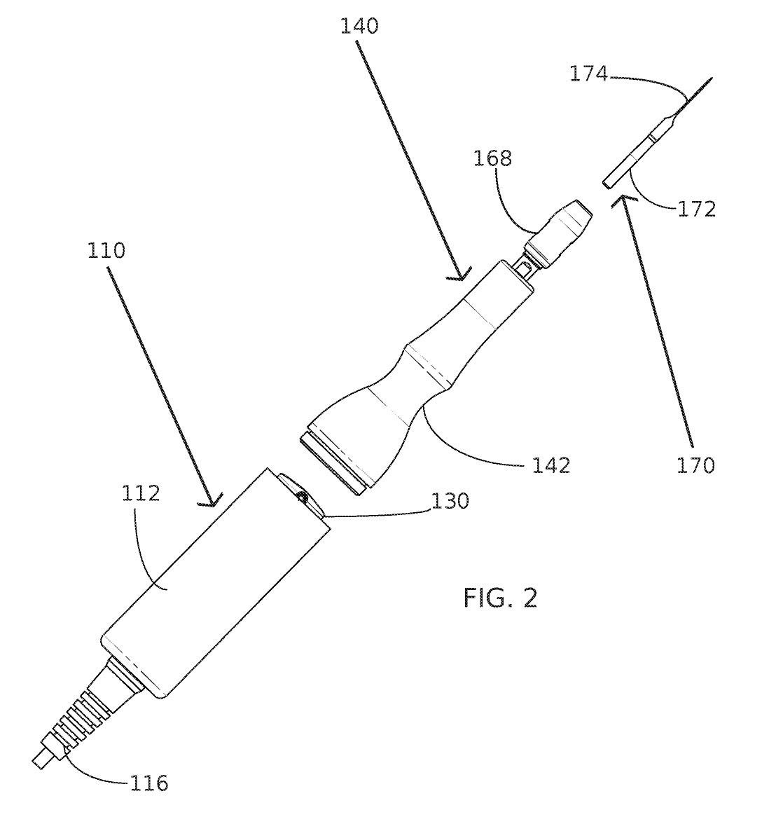

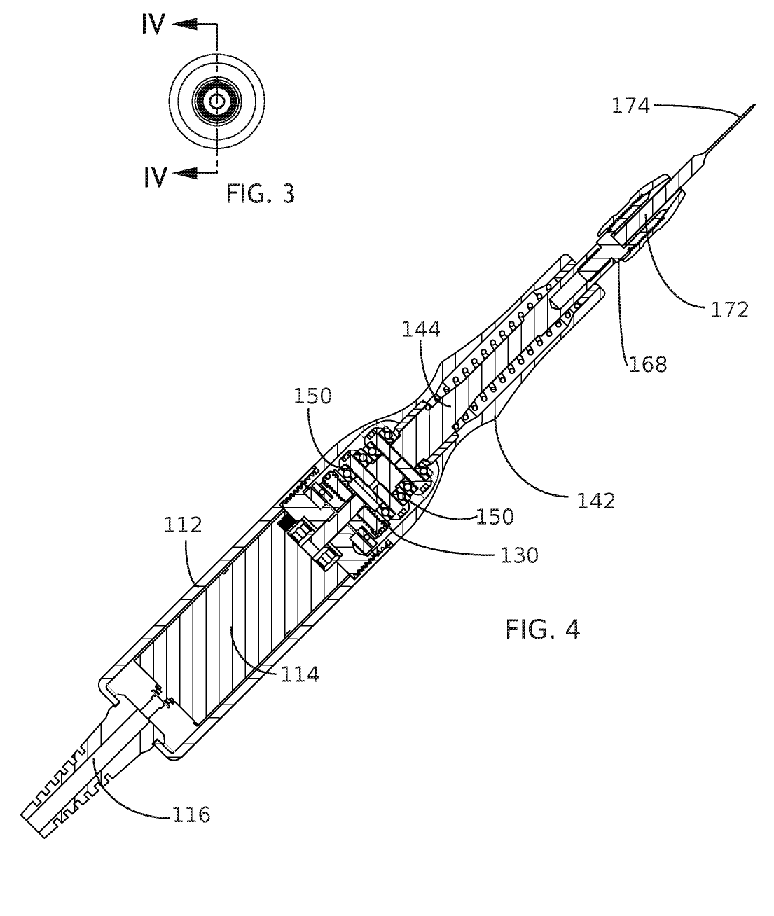

With reference to FIGS. 1-4, the dental surgical tool 100 has three main components, a motor unit 110, a wand head, 140 and a tool bit 170. Each of these components are removable from the other. It should be noted that the tool bit 170 has a bit shoulder 172 for interface with the wand head 140 and a bit head 174 which is used to perform the actual work needed. As such, the bit head 174 may be adaptable to any number of desired operations which require repetitive motion, such as cutting or hammering. The bit head 174, and entire tool 100, may also be adapted for any type of surgical operation outside of dentistry and possibly for any material working operation outside of surgery itself.

Separating the motor unit 110 from the wand head 140 reveals the swash plate 130 and two riding bearings 150 attached to the main shaft 144. The interaction of these components converts the rotary motion of motor 114 into linear motion required for the tool. These components of the motor unit 110 and wand head 140 are contained in respective casings 112, 142, which serve to isolate these moving components from the outside environment by joining together to form a sterile and waterproof seal. A chuck 168 extends outside of the wand head casing 142 and holds the tool bit 170 for use.

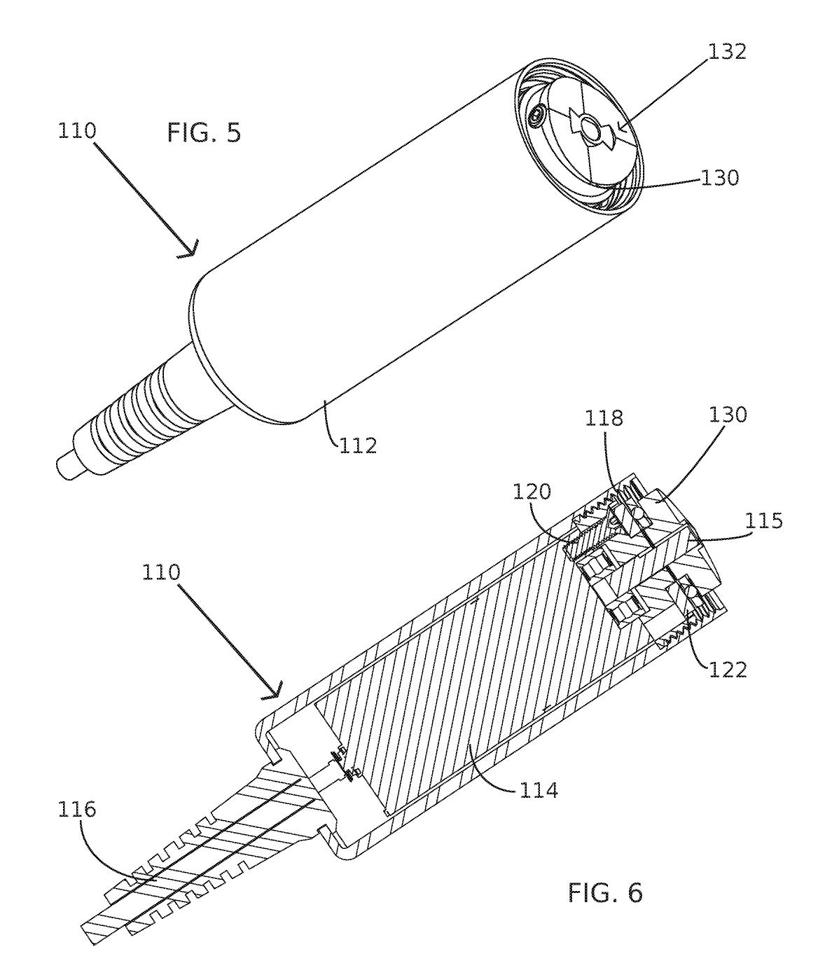

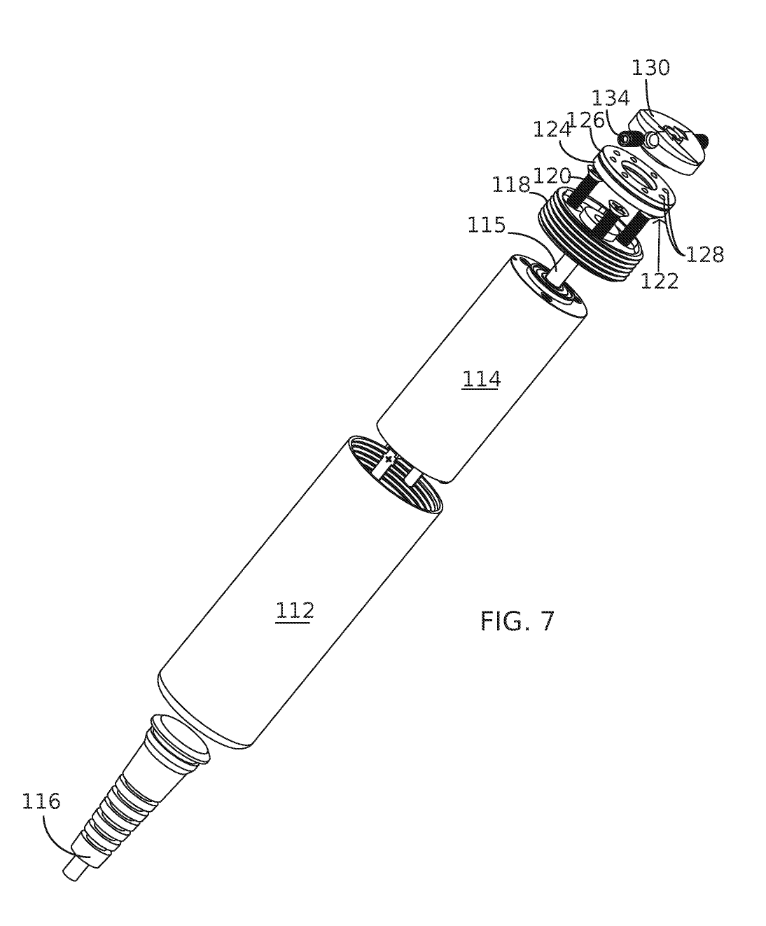

The motor unit 110, as seen in FIGS. 5-7, contains a motor 114 housed within motor unit casing 112. Power for motor 114 may be provided by any means known or later developed, including a simple power cord 116, as is shown, or by utilizing batteries which may or may not be rechargeable and/or replaceable and may or may not utilize an inductive charging system. Limitations regarding the power supply of the surgical tool should not be inferred from the presence of only the illustrated power cord 116. Use of the cord 116 allows for the use of a speed varying foot pedal, which is currently customary in the art. The motor 114 is fastened to a motor mount 118 by the use of any suitable means, such as bolts 120. The motor mount 118 is then secured within the motor unit casing 112 by a threaded interface matching the inner throat of the motor unit casing 112 to the exterior of the motor mount 118. Swash plate 130 is mounted upon the motor spindle 115 and kept in position by a pair of bolts 134. A thrust bearing 122 is located between swash plate 130 and the motor 114. The thrust bearing itself 122 has three main components: a washer base 124, a race 126, and a plurality of ball bearings 128 nested within the top surface of the race 126 (FIG. 7). Swash plate 130 is then free to rotate on the surface of the thrust bearing 122 with as little friction as possible. Of note, the opposite surface of the swash plate 132 is alternately raised and lowered (FIG. 5). The illustrated swash plate 130 has two peaks and two valleys, each diametrically opposed to its match. This provides an alternating push and release on the shaft 144 as a pair of balanced riding bearings 150 roll along the surface 132 (FIG. 4). The use of two alternating valleys and peaks is exemplary—any number of such peaks and valleys could be used so long as they are diametrically opposed so as to match the riding bearings 150. More peaks and valleys would allow a corresponding increase in linear motions with each revolution of the swash plate 130. Changes in motion amplitude for the plunger tip 170 may also be achieved by varying the height of these peaks and valleys.

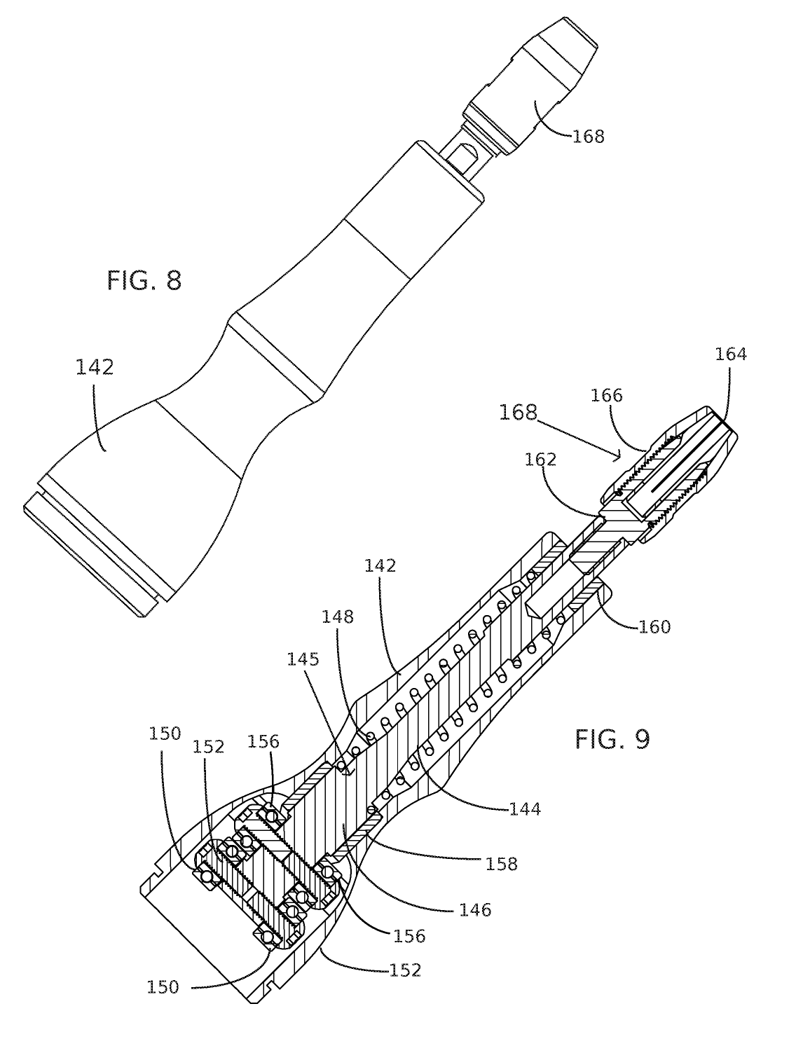

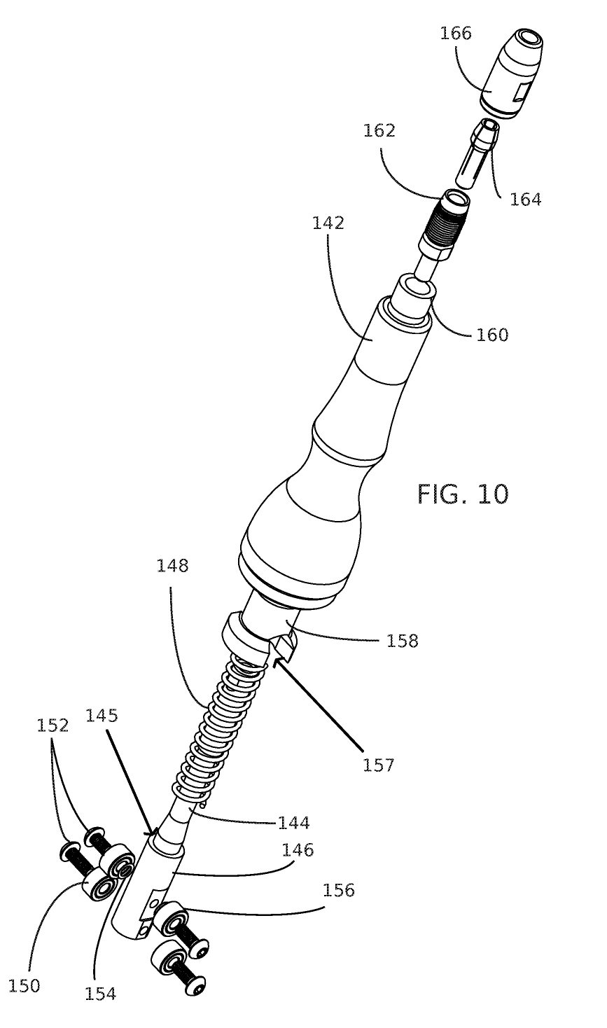

The wand head 140, shown in FIGS. 8-10, features a shaft 144 housed within the center of the wand head housing 142. The shaft has a wider pedestal 146, which forms a shaft shoulder 145. Riding bearings 150 are located on the pedestal 146 and are generally diametrically opposed to each other. As a means of arresting rotational motion by the shaft, locking bearings 156 are also positioned in the pedestal 146, extending diametrically though the same. A fixed rear guide bushing 158 supports the shaft 144 in wand head housing 142 by encompassing the pedestal 146 and nesting the locking bearings 156 in corresponding longitudinal locking slots or keys 157. This interaction of bearings 156 and slot 157 prevent the shaft 144 from rotating along with the swash plate 130 as they interact. All of the bearings 150, 156 are allowed to freely roll through the use of a simple fastening bolt 152 and washer 154 assembly. It should be noted that the use of a simple post in place of the locking bearings 156 could also secure the shaft 144 from rotation but would require significant durability given the rapidly repeating stresses it will encounter.

Spring 148 encompasses the shaft 144 and is supported by the shaft shoulder 145. Is it also supported by a front guide bushing 160 which also serves to support shaft 144. As the swash plate 130 and shaft 144 interact, the shaft 144 will be biased forward, into the head, with each rotation as the riding bearings roll over successive peaks. This will compress spring 148 and store energy. As the swash plate 130 continues and the riding bearings 150 roll into valleys, this spring energy will be released and return the shaft 144 into a retracted position. This longitudinal motion will be continuous as the riding bearings 150 will continually follow the swash plate surface 132. As such, the linear motion of the shaft 144 is a force driven dual acting, reciprocal motion that is smooth, not jarring, and much quieter than previous tools for similar purposes.

At the tool head, a chuck 168 is fastened to the head of shaft 144 and features three main components: a threaded adapter clamp 162 with a cylindrical shaft, a collet 164 residing therein, and a compression nut 166. When compression nut 166 is removed, tool bit 170 may be positioned in collet 164 and secured by the replacement of compression nut 166 about the threaded adapter clamp.

Although the present invention has been described with reference to preferred embodiments, numerous modifications and variations can be made and still the result will come within the scope of the invention. No limitation with respect to the specific embodiments disclosed herein is intended or should be inferred. The tool has been described as being primarily for the art of dentistry but can be adapted to any other surgical art which requires similar motion. Control of the unit may be accomplished by any means known or later found in the art, including the use of a foot pedal switch or other controls.

What is claimed is:

1. A surgical tool comprising:
a housing;
a rotary motor residing within the housing;
a swash plate driven by said rotary motor;
a shaft riding on a first set of bearings in contact with said swash plate;
a spring residing on a shoulder of the shaft, biasing said shaft towards the swashplate; and
a tool head residing on an end of the shaft opposite the first set of bearings;
wherein the swash plate rotates and alternately pushes and releases the first set of bearings and associated shaft against the spring which expands and contracts in response, the interaction of the swash plate and spring thereby imparting reciprocal motion to the shaft.

2. The surgical tool of claim 1, the tool head further comprising a chuck into which a tool bit is receivable.

3. The surgical tool of claim 2, the swash plate featuring two peaks and two valleys.

4. The surgical tool of claim 3, further comprising a means to arrest rotational motion by the shaft.

5. The surgical tool of claim 4, the means to arrest rotational movement by the shaft further comprising a second set of bearings on the shaft and a guide bushing encompassing the shaft within the housing, said second set of bearings residing in longitudinal slots within the guide bushing.

6. The surgical tool of claim 1, the swash plate featuring two peaks and two valleys.

7. The surgical tool of claim 6, further comprising a means to arrest rotational motion by the shaft.

8. The surgical tool of claim 7, the means to arrest rotational movement by the shaft further comprising a second set of bearings on the shaft and a guide bushing encompassing the shaft within the housing, said second set of bearings residing in longitudinal slots within the guide bushing.

9. The surgical tool of claim 1, further comprising a means to arrest rotational motion by the shaft.

10. The surgical tool of claim 9, the means to arrest rotational movement by the shaft further comprising a second set of bearings on the shaft and a guide bushing encompassing the shaft within the housing, said second set of bearings residing in longitudinal slots within the guide bushing.
